(19) United States
(12) Patent Application Publication
(10) Pub. No.: US 2022/0219252 A1
(43) Pub. Date: Jul. 14, 2022

(54) Dust hood device for a power tool and the use thereof, and method for dust collection

(71) Applicant: Hilti Aktiengesellschaft, Schaan (LI)

(72) Inventors: Georg HOLZMEIER, Marktoffingen (DE); Oliver OHLENDORF, Landsberg (DE); Gabriele FUGGER, Unterdiessen (DE)

(21) Appl. No.: 17/606,191

(22) PCT Filed: Apr. 27, 2020
(86) PCT No.: PCT/EP2020/061583

§ 371 Date: Oct. 25, 2021

(30) Foreign Application Priority Data
May 7, 2019 (EP) 19173019.1

(51) Int. Cl. B23D 59/00

(52) U.S. Cl. CPC B23D 59/006

(57) ABSTRACT

A dust hood device for a power tool and to the use thereof and to a method for dust collection. The dust hood device includes, on the lower side thereof, various openings, through which a mixture of air and dust formed during work with the power tool can be extracted. Also disclosed is the use of a dust hood, in particular at various working depths of the power tool, and to a method for dust collection, wherein opening and closing of the openings of the dust hood device can be controlled in accordance with the working depth of the power tool.

### BACKGROUND

The present invention relates to a dust hood device for a power tool and to the use thereof and to a method for dust collection.

It is known that dust can be formed when working with a power tool. Together with the surrounding air, the dust particles form a dust-air mixture, which can represent a health risk for humans. By way of preventive health protection, it is desirable if this dust or the dust-air mixture mentioned can be prevented from getting into the airways of the user of the power tool. Various extraction hoods or dust hoods for power tools are known in the prior art. For example, there are known dust hoods which enclose a work-performing means of the power tool, enabling the dust formed during work with the power tool to be extracted from the hood when the hood is connected to a vacuum cleaning device, for example. The work-performing means of the power tool can be the saw blade of a saw or the cut-off or grinding wheel of an angle grinder, for example. For the purposes of the invention, such work-performing means are referred to as substantially disk-shaped work-performing means or a disk. They usually have a substantially circular area, wherein these work-performing means are generally made to rotate about a central axis of the work-performing means during the operation of the power tool.

### SUMMARY OF THE INVENTION

Most of the conventional dust hoods which are known from the prior art are produced from plastic and cannot be adapted to different ambient conditions or working and/or operating parameters of the power tool, which is a disadvantage. In particular, conventional extraction hoods for power tools with disk-shaped work-performing means often use identical extraction openings, i.e. the dust-air mixture formed during the operation of the power tool is always sucked into the interior of the dust hood through the same openings and, from there, is removed using a vacuum cleaning device. The disadvantage with these conventional dust hoods is that the extraction behavior thereof cannot be adapted to possibly changing ambient conditions or to working and/or operating parameters of the power tool.

However, it has been observed that the dust discharge can vary greatly during the operation of a power tool. For example, the dust discharge can depend on various parameters, such as the working depth of the power tool, the exit angle of the dust or the position of the power tool in relation to the dust hood.

In this context, power tools with disk-shaped work-performing means in which the work-performing means rotates in the same direction as the power tool as a whole represent a particular challenge. For the purposes of the invention, this mode of operation of the power tool, in which the direction of rotation of the work-performing means and the direction of movement of the power tool substantially coincide, is referred to as “unidirectional operation”. In particular, in this case the direction of rotation of the work-performing means and the direction of movement of the power tool are the same. Tests have shown that dust collection in the case of power tools which are operated in the unidirectional operating mode is often made difficult by dust discharge which is counter to dust collection. In other words, it is a particularly difficult and involved matter, owing to the direction and exit angle of the dust in the case of unidirectionally operated power tools for example, to collect the dust completely and effectively to prevent it from getting into the airways of a human being.

A conventional dust hood is known from EP 3 332 907 A1, for example. An extraction nozzle for an extraction hood is disclosed in DE 20 2015 006 749 U 1.

In the case of many extraction devices for power tools, there is furthermore the disadvantage that they are in each case designed only for a single tool and that the extraction devices can thus only be used in conjunction with this single tool. It would be desirable here if it were possible to provide a dust hood device which can be used together with many different tools and is flexible in terms of attachment.

It is furthermore known from the prior art that some dust hoods or extraction devices obstruct the user's view of a work area of the power tool. In the case of some existing solutions, for example, it is not possible to follow a marked cutting line. This problem occurs especially in the working direction in which a pull is exerted.

Yet other solutions known from the prior art require a hole within the dust hood to enable the dust hood to be mounted. However, such a hole creates an unnecessary opening, from which dust can escape. Devices which can be mounted on the power tool only using tools which are in some cases specially designed for the purpose are furthermore known in the prior art. It would be desirable in this case if it were possible to dispense with the use of a special assembly tool or if the mounting of the dust module to be provided could in principle be accomplished without tools.

It is an object of the present invention to overcome the above-described disadvantages of conventional dust hoods and to provide a dust hood device which allows improved extraction behavior, especially in the case of unidirectionally operated power tools. Moreover, an alternate or additional object is, by means of the present invention, to achieve improved extraction behavior in the sense that a possibility for adapting the dust collection process to different ambient conditions or working and/or operating parameters of the power tool is created. A further alternate or additional object is to provide a technical solution which can be secured on the power tool quickly and flexibly and, as far as possible, without the need for a special assembly tool. In addition or alternately, the dust hood device to be provided should be wear-resistant, should not restrict the user's view of the working or cutting area of the power tool, and should be easy to move on the substrate to be worked on.

The present invention provides a power tool, wherein the dust hood device has a lower side. The dust hood device is characterized in that it has, on the lower side thereof, at least one first opening and one second opening for collecting dust, wherein a mixture of dust and air formed by the collection of dust can be guided in various air flows through the interior of the dust hood device in the direction of an extraction nozzle, wherein the air flows in the interior of the dust hood device can be separated from one another by at least one guide element, wherein the first opening serves at least in part as an insertion slot for the work-performing means of the power tool, and the second opening is formed by two side channels and a front slotted opening. In a particularly preferred exemplary embodiment of the invention, it is preferred that the two openings are designed for sucking in dust particles, wherein the mixture of dust and air which is formed can be guided in various air flows through the interior of the dust hood device in the direction of an extraction nozzle, and wherein the air flows in the interior of the dust hood device can be separated from one another by at least one guide element.

For the purposes of the invention, it is preferred that the dust hood device comprises at least one guide element, preferably arranged in the interior of the dust hood device, for separating the air or extraction flows The guide element is preferably designed to separate the air flows produced by the aspiration of the dust-air mixture through the various openings of the dust hood device. The air flows can preferably be guided separately through the interrior of the dust hood. By means of the separation of the various extraction flows, it is advantageously possible to ensure that the at least two openings on the lower side of the dust hood device can be switched independently of one another. For the purposes of the invention, this preferably means that the first and the second opening of the dust hood device can be opened and closed independently of one another, thereby surprisingly making it possible to significantly increase the extraction power of the individual openings. In particular, it is possible to respond to changing ambient conditions of the power tool by means of the independent switching of the openings. In particular, different openings of the dust hood device can be opened or closed in accordance with a working depth of the power tool or of the work-performing means thereof. For the purposes of the invention, it is preferred that the opening and closing of the extraction openings is brought about by the “entry” of the tool into the substrate. In the full cutting mode, for example, all extraction openings apart from the central slot for the tool are closed.

It was completely surprising that particularly effective dust collection could be enabled by the provision of the two openings in the lower side of the dust hood device and the separation of the air flows within the dust hood device, especially if it is a matter of a power tool which is operated in the unidirectional operating mode. In particular, the provision of the openings and the separation of the resulting extraction flows enable the openings to be opened and closed independently of one another. It is thereby possible, by means of the invention, to respond to different ambient conditions and operating parameters of the power tool, e.g. by opening or closing individual openings at different times. For the purposes of the invention, it is very particularly preferred that the first and the second opening of the dust hood device are opened in a cutting-in mode of the power tool and that only the first opening of the dust hood device is opened in a full cutting mode of the power tool. Moreover, improved dust extraction efficiency can surprisingly be provided by means of the invention, especially with unidirectionally operated power tools, since, in the context of the invention, split extraction channels are provided through the provision of the at least two openings and of the at least one guide element.

In particular, the proposed dust hood device is designed to distinguish between different operating modes of the power tool, e.g. the full cutting mode and the cutting-in mode. The distinction between the different operating modes of the power tool is based, in particular, on a setting angle of the intake hood or the change thereof. In other words, the distinction between the different operating modes of the power tool can be made in accordance with a setting angle of the dust hood device. For the purposes of the invention, it is particularly preferred that the different intake channels of the dust hood are opened or closed by changing this setting angle. The setting angle is preferably formed between a lower side of the dust hood and the work-performing means. If the work-performing means is a disk-shaped saw blade, the setting angle can be formed between a radius of the saw blade and the lower side of the hood.

These two operating modes will be explained below in respect of the exemplary embodiment in which the power tool is a saw. For the purposes of the invention, it is preferred that, in the cutting-in mode, the saw or saw blade as the work-performing means of the saw works itself into the material to be divided or sawn up, wherein it has not yet reached the maximum working or cutting depth. In particular, it is the initial cut in the workpiece to be worked upon which takes place in the cutting-in mode. The cutting-in mode is preferably at the beginning of a sawing or dividing operation. The full cutting mode is preferably characterized in that a maximum working or cutting depth of the power tool is achieved. The full cutting mode is therefore preferably after a completed initial cut or after a completed initial cutting phase of the workpiece.

For the purposes of the invention, it is preferred that the term “dust hood” is used synonymously with the term “dust hood device”. The lower side of the dust hood device can preferably face a work-performing means of the power tool. For the purposes of the invention, ion, the air flows may also be referred to as extraction flows. The first opening of the proposed dust hood can preferably also be referred to as the main channel, the insertion slot for the work-performing means of the tool or the cutting gap. The second opening can preferably comprise side channels and a front slotted opening. In other words, the second opening of the proposed dust hood can be formed by two side channels and a front slotted opening. The lower side of the dust hood preferably has a substantially rectangular area, wherein the mutually opposite longer lateral edges of this preferably substantially rectangular area may taper, i.e. converge slightly, in a rear region of the dust hood device or the lower side of the dust hood, for example. This taper of the lateral edges is illustrated in FIG. 1, for example. The side channels, which together with a front slotted opening form the second opening of the dust hood, extend along the lateral edges of the dust hood or the lower side of the dust hood device. The side channels can have a slight bend in the profile thereof, by means of which the side channels follow the profile of the preferably tapering lateral edges. A spacing between the side channels and the lateral edges of the dust hood can be 3 mm, for example. In other words, a preferred wall thickness of the lateral edges of the dust hood device can be about 3 mm.

In a front region of the dust hood device, the side channels preferably extend substantially parallel, while, in a rear region of the dust hood, they converge slightly, although without touching each other. In the front region, the dust hood can have a rounded shape, which generally faces away from the work-performing means of the power tool during the operation of the power tool. A rear region of the dust hood is preferably of level design and is situated in a region of the work-performing means of the power tool during the operation of the power tool. One possible arrangement of the dust hood and the power tool or the work-performing means thereof is illustrated in FIG. 5. In the exemplary embodiment of the invention which is illustrated in FIG. 5, the power tool is formed by a saw and the work-performing means by a saw blade. In the example of arrangement illustrated in FIG. 5, the rear region of the dust hood device is situated at the level of the saw blade, while the front side of the dust hood device, which is not illustrated in FIG. 5, faces away from the saw blade.

In the front region, the dust hood has, on the lower side thereof, a slotted opening, which, owing to its arrangement in the front region of the dust hood device, is preferably also referred to as the “front slotted opening”. In the context of the present invention, the two terms “slotted opening” and “front slotted opening” are preferably used as synonyms. With the two side channels, the slotted opening preferably forms an encircling extraction opening, which surrounds a central region of the lower side of the dust hood on three sides. In particular, the side channels delimit the central region of the lower side of the dust hood on the long sides of the lower side of the dust hood device, while the slotted opening delimits the central region of the lower side of the dust hood on the front side of the dust hood. However, the two side channels and the front slotted opening of the second opening in the interior of the dust hood are preferably separated from one another, wherein this separation is brought about by the guide element. The front slotted opening preferably feeds a first air channel, while the side channels and the first opening of the dust hood device feed a second air channel, wherein the two air channels are preferably separated from one another by the guide element, which is preferably of curved design. For the purposes of the invention, there is a particular preference for the second opening of the dust hood to be formed by an encircling extraction opening, which preferably comprises three individual sections of channel-type design, which are referred to as the first side channel, the second side channel and the front slotted opening. For the purposes of the invention, the term “feed” preferably means that the dust-air mixture, which is sucked in through the front slotted opening, feeds the first air channel, i.e. is passed through the first air channel to the extraction nozzle. The dust-air mixture which is sucked in through the first opening and the side channels of the dust hood preferably passes through the interior of the dust hood via the second air channel before it reaches the extraction nozzle.

For the purposes of the invention, it is preferred that the first opening of the dust hood comprises a main channel, which is preferably also referred to as an insertion slot for the work-performing means of the tool or as a cutting gap. The configuration and arrangement of this main channel are illustrated in FIGS. 1 and 4, for example, which show images of one exemplary embodiment of the invention from below. The first opening of the dust hood is preferably designed to at least partially accommodate the work-performing means of the power tool. If the power tool is a saw, it is preferred for the purposes of the invention that the saw blade of the saw can rotate in the main channel. In the context of the present invention, the saw blade of the saw rotates unidirectionally with the direction of movement of the saw, and therefore the dust hood is arranged in such a way in relation to the saw and the saw blade that the saw blade is preferably guided through the dust hood from below the lower side of the dust hood.

For the purposes of the invention, it is preferred that the dust hood comprises an extraction nozzle by means of which the dust hood device can be connected to a vacuum cleaning device. The extraction nozzle is preferably designed as an extension of the rounded front region of the dust hood, thus enabling the dust-air mixture taken up during dust collection to be guided through the interior of the dust hood device with particularly little obstruction and swirling. The dust hood preferably comprises a casing, which surrounds an interior space of the dust hood. The casing preferably comprises a lower side, which, for its part, comprises the at least first and second opening of the dust hood. The casing of the dust hood furthermore comprises a rear region, which is of substantially level or flat design, and a front region, which has a rounded portion in order to guide the air flows in an optimum manner within the dust hood device. The front region of the dust hood or of the casing of the dust hood can preferably be formed by a front wall or a front outer wall. The casing can furthermore have an extraction nozzle for connecting the dust hood to a vacuum cleaning device. The vacuum cleaning device or the casing thereof can furthermore comprise means for securing the dust hood on the power tool. These fastening means are illustrated in FIG. 3 or 4, for example. They can be of lever-type design and can have an opening for receiving a connecting means, such as a screw, in an upper terminating region. However, it is also possible in the context of the present invention for other fastening means to be used in order to connect the dust hood device to the power tool.

For the purposes of the invention, it is preferred that the at least one guide element extends into the interior of the dust hood device, starting from the lower side of the dust hood device. In an upper region, the guide element substantially follows the profile of the front outer wall of the dust hood. For the purposes of the invention, this preferably means that an upper section of the guide element and the front wall of the casing of the dust hood device can extend substantially parallel. The guide element is preferably of curved or sweeping design. In other words, the guide element is of curved design, wherein the guide element substantially follows the profile of a front outer wall of the dust hood in an upper region. The guide element is preferably designed to separate a first air channel in the interior of the dust hood device from a second air channel. In other words, the guide element is designed to subdivide the interior space of the dust hood device into a first air channel and a second air channel. A first air flow, which is formed by the dust-air mixture that is sucked in by the front slotted opening of the second opening, preferably flows through the first air channel. Moreover, for the purposes of the invention it is preferred that a second air flow, which is formed by the dust-air mixture that is sucked in through the two side channels of the second opening and the first opening of the dust hood, flows through the second air channel. Both air channels preferably open into the extraction nozzle, thus enabling the dust-air mixture sucked in to be removed substantially completely from the interior space of the dust hood with the aid of a vacuum cleaning device.

The second air channel, through which the second air flow preferably flows, comprises an upper extraction region, which is arranged separately from the guide element and adjacent to the first air channel. Moreover, the second air channel comprises a collecting region, which is preferably arranged above the lower side of the dust hood, in the interior space thereof. Both the first and the second air channel can be subjected to a vacuum with the aid of the vacuum cleaning device. By means of this vacuum, preferably produced by the vacuum cleaning device, it is possible to generate the air flows in the interior of the dust hood which serve to collect the dust. For the purposes of the invention, it is preferred that the proposed dust hood is used in addition to a dust hood which surrounds the work-performing means of the power tool. This work-performing means dust hood can also serve, for example, as a combined blade guard of the work-performing means, which is preferably of disk-shaped design. The interaction between the proposed dust hood, the work-performing means dust hood and the work-performing means of the power tool is illustrated in FIG. 5. In other words, it is very particularly preferred, for the purposes of the invention, to use the proposed dust hood device as an additional dust hood in combination with or in addition to an already existing dust hood device for the work-performing means of the power tool. In this sense, the proposed dust hood device can preferably be regarded as a dust hood extension, wherein it can be used to achieve a significantly improved extraction behavior, especially in the case of a unidirectionally rotating work-performing means of the power tool.

It has been found that the vacuum, which preferably comes from a vacuum cleaning device and to which the interior space of the dust hood can be subjected, is at a maximum in a front region of the dust hood. This front region of the dust hood device is preferably arranged behind the front outer wall of the dust hood, which is preferably of rounded design. In particular, this front region of the dust hood is delimited by the front wall of the dust hood on one side and by the guide element on the other side. The lower boundary of this region of the dust hood device preferably forms the front slotted opening of the second opening of the proposed dust hood, while the front region thereof opens upward into the extraction nozzle. The guide element is preferably arranged in the interior space of the dust hood in such a way that the flow rates or pressure conditions in the first air channel and in the second air channel are of comparable magnitude or are of different orders of magnitude. This ensures, particularly in the cutting-in mode of the power tool, that a suction force of substantially equal magnitude on dust particles comes from the various openings of the dust hood. This provides the advantage that particularly uniform extraction of the dust is made possible. For the purposes of the invention, it is particularly preferred that the dimensions and measurements of the air channels and of the corresponding openings are matched to one another in such a way that dust particles are sucked into the different openings of the dust hood with comparable suction forces. In particular, the guide element is present in the interior of the dust hood device in such a way that both the pressure conditions and the measurements of the openings are taken into account in determining the position of the guide element. In other words, it is preferred for the purposes of the invention that a position of the guide element in the interior space of the dust hood can be selected in accordance with the pressure conditions or the dimensions and measurements of the openings of the dust hood.

In a second aspect, the invention relates to a use of a dust hood device, wherein the dust hood device comprises a first opening and a second opening on a lower side. Use takes place, in particular, in conjunction with a power tool and/or a dust hood device for the work-performing means of the power tool. In particular, the dust hood device with a first and a second opening can be used as an additional dust hood device to supplement an already existing dust hood device for the work-performing means of the power tool. One possible location of the guide element within the dust hood is shown by FIG. 3, for example.

For the purposes of the invention, it is preferred that the power tool comprises a substantially disk-shaped work-performing means. In particular, the power tool having the work-performing means of substantially disk -shaped design can be a saw. The work-per-forming means of the power tool can be the saw blade of the saw, for example. For the purposes of the invention, it is furthermore preferred that a direction of rotation of the work-performing means of the tool and a feed direction of the power tool are the same. The sameness of direction of the direction of rotation of the work-performing means of the tool and of the feed direction of the power tool is preferably also referred to as the “unidirectional nature” of the direction of rotation of the work-performing means of the tool and of the feed direction of the power tool. In particular, the direction of rotation of the work-performing means of the tool is referred to as the unidirectional direction of rotation. The invention allows unidirectional operation of the power tool even though a unidirectional direction of rotation of the work-performing means of the tool has been recognized as suboptimal for the sucking in of dust particles. Particularly through the provision of the two openings on the lower side of the dust hood device and the provision of the at least one guide element, optimum inward suction power in relation to dust particles can be made possible even if the power tool is being operated in a unidirectional mode that is not optimum for said tool. To this extent, the use of a dust hood device with openings on the lower side thereof in conjunction with a power tool operating unidirectionally represents a departure from prior art because those skilled in the art had previously assumed that effective dust collection or dust extraction could not be ensured with a dust hood in the case of a unidirectional operating mode of a power tool. The arrangement of the components of the proposed dust hood relative to one another and the interaction between said components are preferably matched to one another in such a way that account can be taken, in particular, of the special fluid-mechanical conditions in a unidirectional operating mode of a power tool.

In a particularly preferred exemplary embodiment of the invention, a direction of rotation of the saw blade of a saw and the feed direction of the saw, in particular, are the same. In particular, the direction of rotation of the saw blade of the saw is referred to as the unidirectional direction of rotation of the saw blade. In other words, the dust hood device is preferably used in conjunction with a saw and/or a dust hood device for a saw blade of the saw, wherein a direction of rotation of the saw blade of the saw and a feed direction of the saw are the same. In particular, the dust hood is used to supplement an already existing dust hood device for the saw blade of the saw, wherein the already existing dust hood is preferably designed to surround the saw blade of the saw substantially completely and to suck in the dust which is formed or disturbed in the surroundings of the saw blade. Through the provision of the two openings on the lower side of the proposed dust hood and the provision of at least one guide element in the interior thereof, said hood advantageously makes possible optimum sucking in of dust and dust particles, even if the saw is operated in a unidirectional mode, which is not optimum for this purpose. For example, the saw in this exemplary embodiment can be moved in a “forward” direction in space if it is used for sawing. For the purposes of the invention, the unidirectional mode of the saw preferably means that the saw blade of the saw also rotates in a “forward” direction in space, and therefore the direction of rotation of the saw blade and the direction of movement of the saw are the same “forward” direction in space. For the purposes of the invention, the “forward” direction in space can be made equivalent to the power tool being moved away from a user, while, in the case of a “rearward” movement of the power tool, the power tool is moved in the direction of a user. For the purposes of the invention, a “downward” direction in space is defined by the position or location of the lower side of the dust hood device, while the “upward” direction in space may be defined by the fact that the extraction nozzle or the fastening means point in the “upward” direction in space, for example. To this extent, said directions in space and location indications are not unclear terms for a person skilled in the art.

In a preferred configuration of the invention, the first and the second opening of the dust hood device are open in a cutting-in mode of the power tool. This is the case especially during dust collection. It is preferred that, in the context of the present invention, the openings on the lower side of the proposed dust hood can be opened and closed in accordance with a working depth of the power tool. The invention makes it possible, in particular, to control opening and closing of the first and/or the second opening of the dust hood device in such a way that the first and the second opening of the dust hood device are open in a cutting-in mode of the power tool or that only the first opening of the dust hood device can be opened in a full cutting mode. In other words, the proposed dust hood is designed to enable the openings thereof to be opened and closed in accordance with a cutting depth when the power tool is a saw. In particular, it is preferred for the purposes of the invention that, in a full cutting mode, the cutting gap, which preferably forms the first opening of the dust hood, is open only while the second opening, which preferably comprises two side channels and a front slotted opening is closed. In a cutting-in mode, the first and the second opening of the dust hood are preferably open, i.e. both the main channel, which preferably forms the first opening of the dust hood, and the side channels and the front slotted opening, which preferably form the second opening.

In a full cutting mode, only the first opening of the dust hood device is preferably open. A very high flow rate in the extraction flow caused by the first opening is thereby advantageously achieved. By means of the high flow rate in the air flow which is fed by the first opening, particularly good and effective dust collection is achieved during the operation of the saw in the full cutting mode.

In another aspect, the invention relates to a method for collecting dust by means of a dust hood device for a power tool, wherein the power tool comprises a work-performing means. The method comprises the following steps:
a) providing a dust hood device having at least one first opening and one second opening, wherein the first opening serves at least in part as an insertion slot for the work-performing means of the power tool, and the second opening is formed by two side channels and a front slotted opening,
b) fastening the dust hood device on the power tool,
c) operating the power tool, wherein it is possible, in particular, to operate the power tool in a cutting-in mode and in a full cutting mode,
d) opening the first opening in a full cutting mode of the power tool, or
e) opening the first and the second opening in a cutting-in mode of the power tool.

For the purposes of the invention, it is very particularly preferred that the power tool is operated in the unidirectional operating mode. If, according to a particularly preferred configuration of the invention, the power tool is a saw, the method for dust collection can be characterized by the following method steps:
a) providing a dust hood device having at least one first opening and one second opening,
b) fastening the dust hood device on a saw,
c) operating the saw, wherein it is possible, in particular, to operate the saw in a cutting-in mode and in a full cutting mode,
d) opening the first opening in a full cutting mode of the saw, or
e) opening the first and the second opening in a cutting-in mode of the saw.

In other words, it is preferred for the purposes of the invention that the first and the second opening of the dust hood device are open during dust collection in a cutting-in mode of a power tool, and that only the first opening of the dust hood device is open during dust collection in a full cutting mode. For the purposes of the invention, there may be a preference for the use of a proposed dust hood device for the proposed method. However, the preference may be to use a dust hood device that has at least two openings for sucking in dust or dust particles on a lower side for the proposed method. For the purposes of the invention, it is very particularly preferred that the power tool is operated in a unidirectional operating mode in the context of the proposed method, i.e. that a direction of movement of the power tool during work and a direction of rotation of the work-performing means of the power tool are the same. In particular, the power tool can be moved “forward” in one direction in space, while the work-performing means likewise rotates in a “forward” direction in space.

For the purposes of the invention, it is preferred that a mixture of dust and air formed by dust collection is guided through the interior of the dust hood device in the direction of the extraction nozzle in various air flows. In particular, the air flows can be guided through the first and the second air channel, which are separated from one another by the guide element of the dust hood. In other words, it is preferred for the purposes of the invention that the air flows are separated from one another by at least one guide element in the interior of the dust hood device.

The definitions, technical effects and advantages of the invention which have been described in connection with the dust hood apply to the use of the dust hood and to the method for dust collection in an analogous manner.

5068.1377 substitute specification clean

For the purposes of the invention, it is preferred that the proposed dust hood device is of modular construction in the sense that it comprises two halves or can be manufactured from at least two components. In particular, the dust hood is used to extract dust which is formed during the working of a power tool. It can thus preferably also be referred to as an extraction device. The dust hood can be connected to a blade guard or a dust hood, which encloses the work-performing means of the power tool, wherein, in particular, the proposed dust hood device has an extraction nozzle for connecting the device to a vacuum cleaning device. The casing of the dust hood device is preferably formed by two halves, although these are not of symmetrical design. This is the case, in particular, because one of the halves comprises the extraction nozzle for connecting the device to a vacuum cleaning device. The two halves are preferably manufactured from plastic or comprise one or more plastics, in whole or in part. One particular advantage of the invention is that the two halves of the dust hood device can be connected to one another using a fastening means without an additional tool. The fastening means can be a screw, for example, which can preferably comprise a star knob. In particular, the two halves of the dust hood device can be braced or clamped together with the aid of the screw.

For the purposes of the invention, it is preferred that, for mounting on the blade guard of the power tool, the two halves of the dust hood device are separated from one another and pushed apart by screwing on the fastening means. The pushing apart of the two halves is made easier by a linear guide. The guide can be formed, for example, by a dome on one half of the dust hood device and a corresponding hole in the other half of the dust hood device, which can interact with one another. In this case, a maximum spacing of the two halves can be set or limited by the use of at least one retaining washer. For the purposes of the invention, it is particularly preferred that two retaining washers are used, which are arranged on a common shaft. The shaft with the retaining washers advantageously prevents the two halves of the dust hood device from being completely separated from one another. In other words, the shaft with the retaining washers represents a safeguard against the loss of the two halves of the dust hood device with respect to one another. For the purposes of the invention, it is preferred that the halves of the dust hood device can be pushed onto the dust hood of a power tool after having been pushed apart. The two halves of the extraction device can then be connected to one another again. Another advantage of the invention consists in that positive engagement with a mating contour is formed by the connection of the two halves of the extraction device, by means of which positive engagement fastening of the extraction device on the blade guard of a power tool can be made significantly easier. This positive engagement can preferably be formed when the fastening means is tightened, with the result that the dust hood device is connected firmly to the blade guard or the work-performing means dust hood of the power tool.

Wheels can furthermore be provided on the shaft, which forms the safeguard against loss together with the retaining washers, to enable the device to be moved over the substrate more easily. The wheels advantageously enable the user to make the power tool roll over the substrate with surprisingly little expenditure of force during operation. It is thereby possible, in particular, to avoid the dragging over the substrate which is common with conventional power tools. Moreover, the wheels can be used as a pivot point to enable simple and defined penetration into the substrate to be worked upon.

For the purposes of the invention, it is preferred that the extraction nozzle of the extraction device or of the dust hood device is designed as a cone. This preferred configuration of the extraction nozzle is illustrated in FIG. 6. For the purposes of the invention, it is particularly preferred that the extraction nozzle acts as an interface with a vacuum cleaning device by means of which the dust which forms during work with the power tool can be extracted.

The proposed dust hood device preferably has a metal rail on the lower side thereof. The metal rail can preferably comprise steel or be formed from steel. Through the provision of the metal rail, it is advantageously possible to considerably improve the wear resistance of the dust hood device. The lower side is particularly susceptible to wear since it is pulled over the substrate to be worked upon when the dust hood device is used. The metal rail can be embodied in two parts, for example, and be formed by two metal skids. The metal skids can advantageously be arranged on the lateral edges of the lower side of the device, where they effectively avoid abrasion of the plastic of which the device preferably consists.

Significant advantages of the invention are stated below: owing to its modular construction, the dust hood device can be assembled particularly easily, quickly and in an uncomplicated manner from two halves. Disassembly, in particular, can be carried out quickly and without an additional tool. Such disassembly may be required, for example, if the power tool is to be used for wet applications or for cutting steel. In the disassembled state, the dust hood device is advantageously of loss-proof design, and therefore a loss of fastening means, such as screws or the like, is reliably avoided. The proposed dust hood device can be embodied in a particularly compact and space-saving manner and thus impairs the view of the user of the work area of the power tool only to a slight extent, if at all.

Further advantages can be found in the following description of the figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, components which are the same and components of the same type are denoted by the same reference signs. In the figures:

FIG. 1 shows a view of a lower side of a preferred embodiment of the proposed dust hood device

FIG. 2 shows a side view of a preferred embodiment of the proposed dust hood device

FIG. 3 shows a sectional illustration of a preferred embodiment of the proposed dust hood device

FIG. 4 shows an oblique view of a preferred embodiment of the proposed dust hood device

FIG. 5 shows a view of a preferred embodiment of the proposed dust hood device in conjunction with a work-performing means of a power tool

FIG. 6 shows various views of a preferred embodiment of the proposed dust hood device with a conical extraction nozzle

FIG. 7 shows a plan view of a preferred embodiment of the proposed dust hood device

FIG. 8 shows various views of a preferred embodiment of the dust hood device with a specially designed extraction nozzle

FIG. 9 shows a view of a preferred embodiment of the dust hood device in conjunction with a work-performing means of a power tool and a blade guard

### DETAILED DESCRIPTION

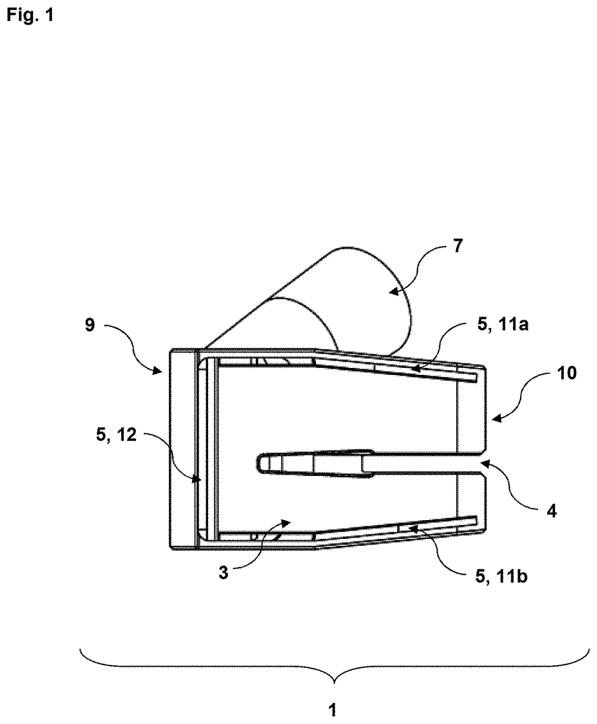

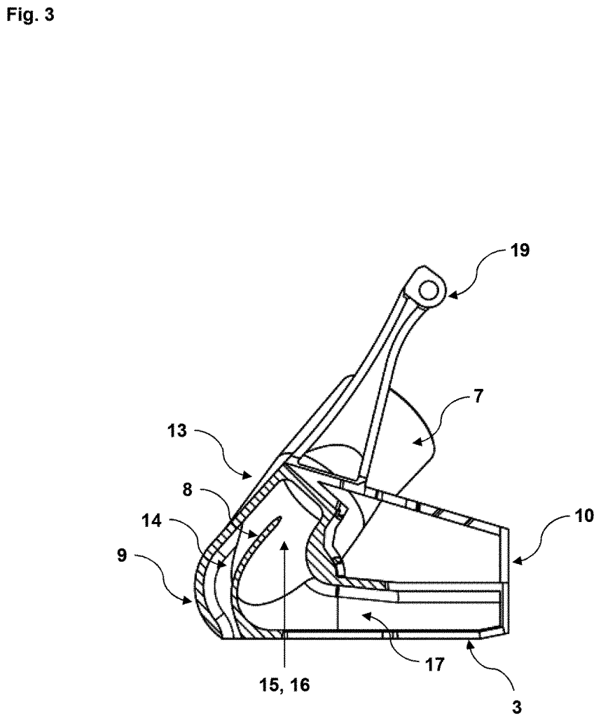

FIG. 1 shows a lower side (3) of a preferred embodiment of the dust hood device (1). The power tool (2) on which the dust hood (1) can be secured is not illustrated in the figures. The dust hood device (1) has various openings (4, 5, 11a, 11b, 12) on the lower side (3) thereof. A first opening (4) is formed, for example, by a main channel, which serves at least in part as an insertion slot for the work-performing means (18) of the power tool (2). This insertion slot (4) is preferably open both in the full cutting mode and in the cutting-in mode of the power tool (2). On its lower side (3), the dust hood device (1) furthermore comprises a second opening (5), which can be formed by side channels (11a, 11b) and a front slotted opening (12). The slotted opening (5) preferably extends substantially parallel to a front edge of the dust hood device (1). For the purposes of the invention, it is preferred that the slotted opening (12) is present in a front region of the dust hood device (1), wherein the dust hood device (1) is delimited in the front region (9) by a rounded outer wall (13) or front side. The rear side (10) of the dust hood device (1) can preferably be level or flat. The side channels (11a, 11b) are arranged substantially perpendicular to the front slotted opening (12), but this is separate from the front slotted opening (12) in the interior of the dust hood (1). In particular, the front slotted opening (12) feeds a first air channel (14), while the side channels (11a, 11b) and the main channel (4) feed a second air channel (15) of the dust hood device (1). In an upper region of the dust hood (1), the air channels (14, 15) {see,e.g., FIG. 3) open into an extraction nozzle (7), which can be connected to a vacuum cleaning device. Via the extraction nozzle (7), the dust hood device (1) can advantageously be subjected to a vacuum, using the vacuum cleaning device, wherein the vacuum is distributed particularly uniformly in the interior (6) of the dust hood (1) by virtue of the arrangement of the guide element (8). It is thereby advantageously possible to provide uniform pressure conditions and intake forces in the air channels (14, 15) and in the openings (4, 5, 11, 12) which are assigned to the air channels (14, 15).

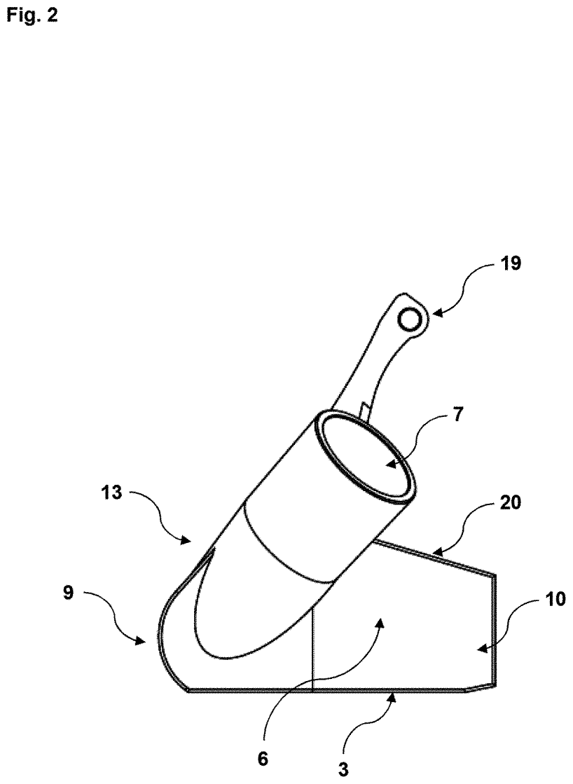

FIG. 2 shows a side view of a preferred embodiment of the dust hood device (1). In particular, FIG. 2 shows a dust hood (1) which has an extraction nozzle (7) on a side facing the observer, while, on a side facing away from the observer, the dust hood (1) has a preferably lever-type fastening means (19), by means of which the dust hood device (1) can be secured on a power tool (2). Through the opening in the upper region of the fastening means (19) it is possible, for example, to pass a screw as a connecting means, by means of which the dust hood (1) can be secured on another dust hood of the power tool (2) or on a blade guard of the work-performing means (18) of the power tool (2).

In the exemplary embodiment of the invention which is illustrated in FIG. 2, the dust hood (1) is bounded toward the outside by a casing (20), wherein the casing (20) can be formed by two mutually corresponding halves, for example. Owing to the provision of the extraction nozzle (7), the two halves of the casing (20) of the dust hood (1) are preferably not formed symmetrically with one another. For the purposes of the invention, it is preferred, in particular, that the first opening (4) (see, e.g., FIG. 1) of the dust hood device (1) is not arranged centrally on the lower side (3) thereof but that the half of the casing (20) of the dust hood (1) which comprises the extraction nozzle (7) is of somewhat wider design than the half of the casing (20) of the dust hood device (1) which comprises the fastening means (19). In particular, the casing (20) of the dust hood device (1) surrounds an interior space (6) which, for the purposes of the invention, is preferably also referred to as the «interior» of the dust hood device (1).

Illustrated on the left-hand side of FIG. 2 is the front region (9) of the dust hood (1), which is delimited, in particular, by a front outer wall (13) or front wall of the dust hood device (1). In particular, FIG. 2 shows the rounded design of the front region (9) of the dust hood device (1). The rear side (10) of the dust hood device (1) is illustrated on the right-hand side of FIG. 2, wherein the rear side (10) of the dust hood (1) is preferably of flat design.

FIG. 3 shows a sectional view of a preferred embodiment of the proposed dust hood device (1). In particular, FIG. 3 shows the guide element (8) or the position thereof in the interior (6) of the exemplary embodiment of the proposed dust hood device (1) which is illustrated in FIG. 3. Starting from the lower side (3) of the dust hood device (1), the guide element (8) extends in the direction of the extraction nozzle (7) and separates a first air channel (14) from a second air channel (15). The first air channel (14) is preferably arranged in the front region (9) of the dust hood (1). The second air channel (15) preferably comprises an extraction region (16) and a collecting region (17). The extraction region (16) preferably forms the upper region of the second air channel (15), which merges into the extraction nozzle (7). The collecting region (17) of the second air channel (15) preferably extends substantially parallel to the lower side (3) of the dust hood device (1) and, in particular, above the side channels (11a, 11b) and above the main channel (4), in which the work-performing means (18) of the power tool (2) may be situated, at least in part. The first air channel (14) preferably extends between the guide element (8) and the front wall (13) of the dust hood device (1). The lower outlet of the first air channel (14) preferably forms a section of the second opening (5) of the proposed dust hood (1), in particular the front slotted opening (12)(see. E.g., FIG. 1).

The front slotted opening (12) can have a width of 5 to 10 mm, for example, wherein a width of 7.5 mm has proven particularly advantageous for the extraction behavior of the dust hood (1). The side channels (11a, 11b) preferably have a width of 1 to 5 mm, wherein, in particular, a width of 3 mm allows effective dust collection here. The central tool opening channel (4) can preferably have a width of 2 to 10 mm, wherein a width of 6 mm is particularly preferred. It has been found that a particularly good dust collection and extraction behavior of the dust hood device (1) is achieved with a combination of the width of the slotted opening (12) of 7.5 mm, of the side channels (11a, 11b) of 3 mm and of the first opening (4) of 6 mm.

FIG. 3 furthermore shows the device (19), preferably of lever-type design, for securing the dust hood device (1) on the power tool (2), and the rear side (10) of the dust hood (1).

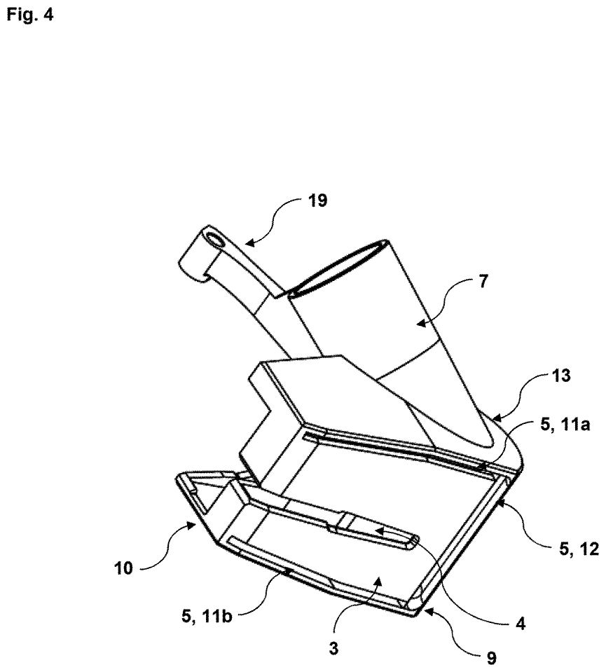

FIG. 4 shows an oblique view of a preferred embodiment of the proposed dust hood device (1). In addition to the objects already shown in the previous figures, FIG. 4 shows, in particular, a possible preferred structuring or configuration of the lower side (3) of the dust hood device (1). The side channels (11a, 11b) are arranged at the sides of the lower side (3), illustrated in FIG. 4, of the dust hood (1). Arranged in a front region (9) of the dust hood device (1) there is preferably a slotted opening (12), which, together with the side channels (11a, 11b), forms the second opening (5) for the purposes of the invention, wherein this second opening (5) can be closed in the full cutting mode of the power tool (2), for example. Beginning in the transitional region between the side channels (11a, 11b) and the front slotted opening (12) there is the guide element (8), which extends into the interior (6) of the dust hood device (1) and there separates the two air channels (14, 15) from one another.

In the rear region (10) of the dust hood device (1), the first opening (4) first of all has substantially parallel lateral edges. In this region of the first opening (4), the work-per-forming means (18) of the power tool (2) can rotate when the proposed dust hood device (1) is present in a manner connected to a power tool (2). This region of the first opening (4) is preferably referred to as the rear section or as the work-performing means region of the first opening (4). Subsequently—in the direction of the front region (9) of the dust hood device (1)—the first opening (4) widens. This region of the first opening (4) is preferably referred to as the extraction region or front region of the first opening (4) of the proposed dust hood (1). The rear region of the first opening (4) is preferably designed to at least partially accommodate the work-performing means (18) of the power tool (2), while the front region of the first opening (4) is used for dust collection, namely preferably both in the cutting-in mode and in the full cutting mode. The dust-air mixture sucked in through the first opening (4) is conveyed in the direction of the extraction nozzle (7) through the second air channel (15) together with the dust-air mixture sucked in through the side channels (11a, 11b), while the dust-air mixture which is sucked in through the front slotted opening (12) is conveyed in the direction of the extraction nozzle (7) through the first air channel (14) in the front region (9) of the dust hood device (1).

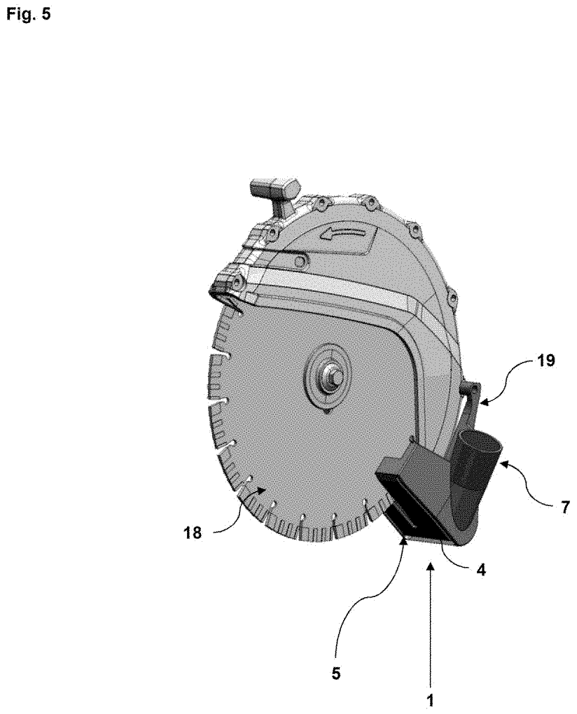

FIG. 5 shows a view of a preferred embodiment of the proposed dust hood device (1) in conjunction with a work-performing means (18) of a power tool (2). In particular, FIG. 5 shows a possible orientation of the work-performing means (18) and the dust hood (1) relative to one another. For example, the work-performing means (18), illustrated in figure 5, of the power tool (2) rotates within the rear region of the first opening (4) of the dust hood device (1), while the front region of the first opening (4) remains substantially free in order to be able to collect dust. Furthermore, FIG. 5 shows the second opening (5) and a possible arrangement of this second opening (5) on the lower side (3) of the illustrated dust hood (1). The dust hood device (1) can be secured by a fastening means (19) on the power tool (2) or on a further dust hood of the power tool (2) or on a blade guard for the work-performing means (18) of the power tool (2). According to a particularly preferred embodiment of the invention, the work-performing means (18) illustrated in FIG. 5 can be a saw blade, which can be secured on a saw as a power tool (2).

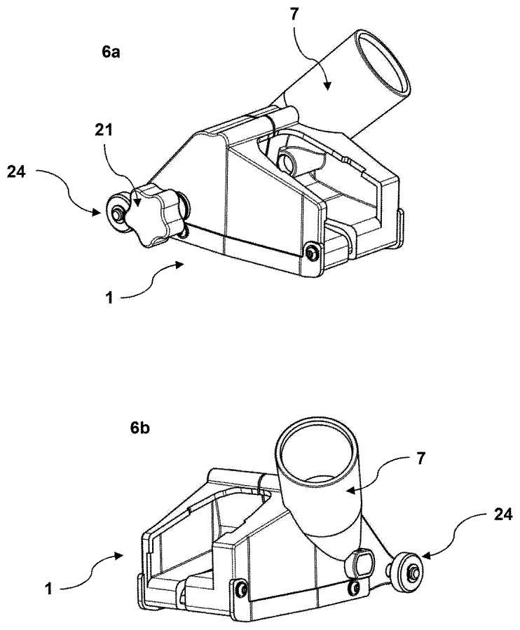

FIG. 6 shows various views of a preferred embodiment of the proposed dust hood device (1) with a conical extraction nozzle (7). Moreover, FIG. 6 illustrates the fastening means (21), which connects the two halves of the dust hood device (1) to one another. The fastening means (21) can preferably be designed as a screw and can comprise a star knob. FIG. 6 furthermore illustrates the wheels (24) of the dust hood device (1). These can be arranged on a shaft (22), on which the retaining washers (23), which form the safeguard against loss of the dust hood device (1) together with the shaft (22), can be arranged.

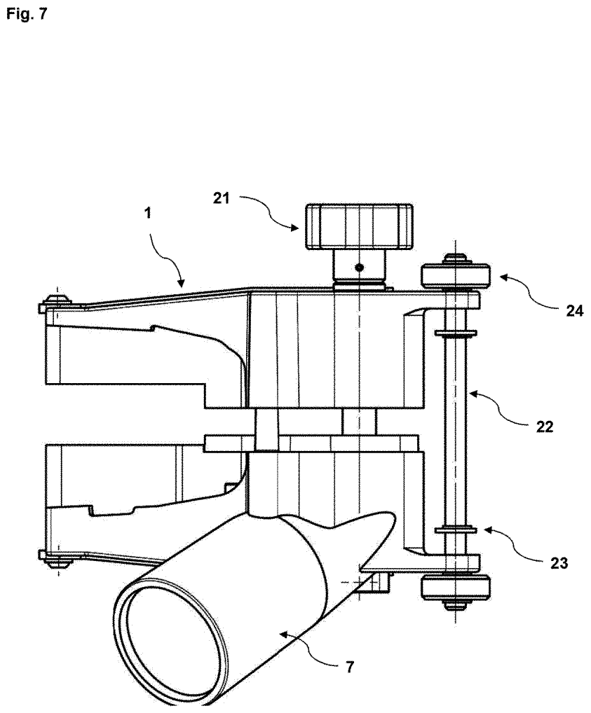

FIG. 7 shows a plan view of a preferred embodiment of the proposed dust hood device (1). The extraction nozzle (7), the wheels (24) as well as the shaft (22) with the retaining washers (23) and the fastening means (21) having a star knob are clearly visible in FIG. 7.

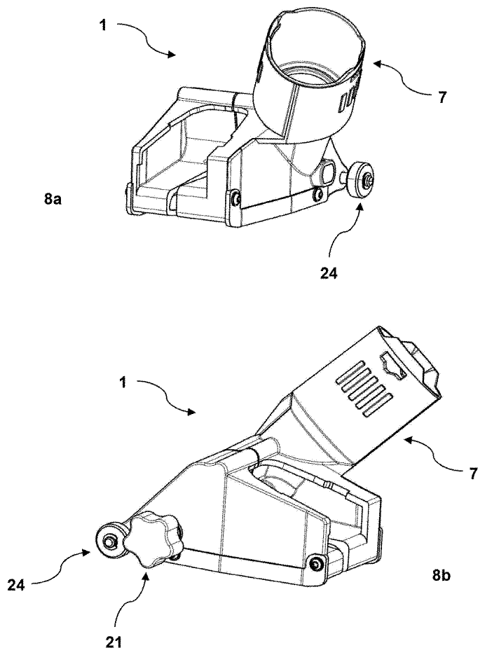

FIG. 8 shows various views of a preferred embodiment of the proposed dust hood device (1) with an extraction nozzle (7) configured in an alternative way.

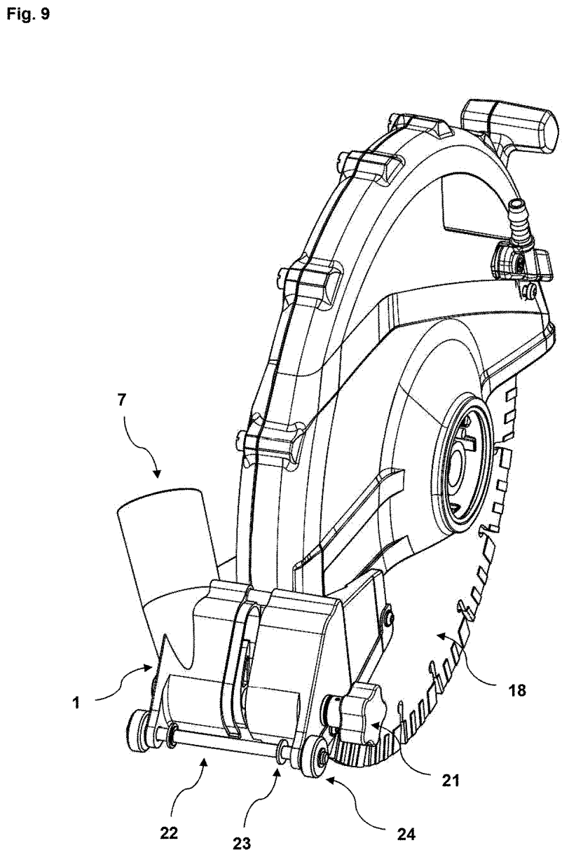

FIG. 9 shows a view of a preferred embodiment of the proposed dust hood device (1) in conjunction with a work-performing means (18) of a power tool (2). It furthermore illustrates the shaft (22) with the retaining washers (23), the wheels (24), which can preferably be on the same shaft (22) as the retaining washers (23), and the screw (21) with the star knob.

### LIST OF REFERENCE SIGNS

1 Dust hood device or dust hood

2 Power tool

3 Lower side of the dust hood

4 First opening

5 Second opening

6 Interior space of the dust hood

7 Extraction nozzle

8 Guide element

9 Front region of the dust hood

10 Rear region of the dust hood

11a, b Side channels

12 Front slotted opening

13 Front outer wall of the dust hood, front side

14 First air channel

15 Second air channel

16 Upper extraction channel

17 Collecting region

18 Work-performing means of the power tool

19 Fastening means

20 Casing of the dust hood

21 Screw with star knob

22 Shaft

23 Retaining washers

24 Wheels

1 to 14 (canceled)

15. A dust hood device for a power tool having a work-performing means, the dust hood device comprising:
on a lower side, at least one first opening and at least one second opening for collecting dust, a mixture of dust and air formed by the collection of dust guidable in various air flows through an interior of the dust hood device in a direction of an extraction nozzle, the various air flows in the interior of the dust hood device separable from one another by at least one guide element, the at least one first opening serving at least in part as an insertion slot for the work-performing means of the power tool, and the at least one second opening is formed by two side channels and a front slotted opening.

16. The dust hood device as recited in claim 15 wherein the at least one guide element extends into the interior of the dust hood device, starting from the lower side of the dust hood device.

17. The dust hood device as recited in claim 15 wherein the guide element is of curved design, wherein the guide element follows a profile of a front outer wall of the dust hood device in an upper region.

18. The dust hood device as recited in claim 15 wherein the guide element divides the interior of the dust hood device into a first air channel and a second air channel.

19. The dust hood device as recited in claim 18 wherein the second air channel includes an upper extraction region arranged separately from the guide element, adjacent to the first air channel, and a collecting region arranged above the lower side of the dust hood device in the interior.

20. The dust hood device as recited in claim 18 wherein the dust hood device is of a modular construction consisting of two halves.

21. The dust hood device as recited in claim 15 further comprising a shaft designed as a safeguard against loss.

22. The dust hood device as recited in claim 21 wherein the shaft of the dust hood device is designed to receive wheels.

23. The dust hood device as recited in claim 15 wherein the extraction nozzle is designed as a cone.

24. The dust hood device as recited in claim 15 further comprising at least one metal rail on the lower side for reducing wear.

25. A method comprising:
using a dust hood having at least one first opening and at least one second opening on a lower side, in conjunction with a power tool or a dust hood device for a work-performing means of the power tool

26. The method as recited in claim 25 wherein a direction of rotation of the work-performing means of the tool and a feed direction of the power tool are the same.

27. The method as recited in claim 25 wherein a mixture of dust and air formed by collection of dust is guided in various air channels through an interior of the dust hood device in the direction of an extraction nozzle.

28. A method for collecting dust via a dust hood device for a power tool having a work-performing means, the method comprising the following steps:
a) providing a dust hood device having a lower side, the dust hood device including at least one first opening and at least one second opening on a lower side, wherein the at least one first opening serves at least in part as an insertion slot for the work-performing means of the power tool, and the at least one second opening is formed by two side channels and a front slotted opening;
b) fastening the dust hood device on the power tool;
c) operating the power tool, the power tool operable a cutting-in mode and a full cutting mode;
d) opening the first opening in the full cutting mode of the power tool; or
e) opening the first opening and the second opening in the cutting-in mode of the power tool.

29. The method as recited in claim 28 wherein a mixture of dust and air formed by collection of dust is guided in various air channels through an interior of the dust hood device in the direction of an extraction nozzle.
